(19) United States
(12) Patent Application Publication
(10) Pub. No.: US 2017/0218313 A1
(43) Pub. Date: Aug. 3, 2017

(54) CLEANING FLUIDS AND METHODS OF CLEANING MICROFLUIDIC CHANNELS

(71) Applicant: PSG INSTITUTIONS, Coimbatore, Tamil Nadu (IN)

(72) Inventor: Rama Ranjan BHATTACHARJEE, Kolkata, West Bengal (IN)

(73) Assignee: PSG INSTITUTIONS, Coimbatore, Tamil Nadu (IN)

(21) Appl. No.: 15/117,998

(22) PCT Filed: Nov. 19, 2014
(86) PCT No.: PCT/IB14/66154

§ 371 Date: Aug. 10, 2016

(30) Foreign Application Priority Data
Feb. 10, 2014 (IN) 598/CHE/2014

(51) Int. Cl. C11D 11/00; C11D 3/12; B08B 9/027; C11D 1/04

(52) U.S. Cl. CPC C11D 11/0047; C11D 1/04; C11D 3/1213; B08B 9/027

(57) ABSTRACT

Cleaning fluids and methods for cleaning microfluidic channels are disclosed. The cleaning fluid includes surfactant coated magnetic particles, and the cleaning fluid may be guided into, through and out of the channels by using a magnetic field.

### BACKGROUND

In the area of sensors and devices, a ‘Lab on a Chip’ (LOC) concept integrates one or several laboratory functions onto a single chip having a size of only millimeters to a few square centimeters. The microfluidic channels play a role in designing these devices. Some of the fabrication processes may include glass, ceramic, and metal etching, deposition and bonding, polydimethylsiloxane (PDMS) processing, soft lithography, thick-film- and stereolithography, and fast replication methods via electroplating, injection molding, and embossing.

A large proportion of microfluidic devices are made from PDMS, but PDMS is, however, known to absorb hydrophobic molecules that may be present in fluids, such as oils, drugs, and dyes, for example, that may be used with the devices. One type of re-usable device for florescence measurements, for example, may use at least one fluorescent dye. Over time, an increasing amount of dye may be absorbed within the device, and this may provide a significant background signal, thus making fluorescence-based measurements imprecise. The problem may be further exacerbated at higher fluidic temperatures as the rate of absorption into the device may increase.

Because of the size of the channels, fluid within the channels may also be difficult to remove. For example, due to capillary action, fluid that may be pulled into the channels may tend to remain within the channels. Flushing the channels may also be difficult due to the small size. Available cleaning fluids may not work with microfluidic channels, may be toxic, may degrade the material of the channels, or may be labor intensive to use.

Therefore, for microfluidic devices, especially for re-usable devices, there remains a need for efficiently cleaning the channels via a non-toxic water based approach to remove any residual materials, such as dyes that may be retained in the channels.

### SUMMARY

To facilitate cleaning of microfluidic channels, a cleaning fluid may include magnetic particles coated with a surfactant. Since the cleaning fluid contains magnetic particles, the cleaning fluid may be guided into and out of the channels by means of a magnetic field.

In an embodiment, a method for cleaning a microfluidic channel includes introducing a microfluidic channel cleaning fluid that includes surfactant coated magnetic nanoparticles into an opening of the microfluidic channel, applying a magnetic field adjacent the microfluidic channel, and leading the cleaning fluid through the mi.crofluidic channel with the magnetic field.

In an embodiment, a method for removing undesired materials from a microfluidic channel includes introducing a cleaning fluid that includes magnetic nanoparticles coated with surfactant to an opening of a microfluidic channel, applying a magnetic field adjacent the microfluidic channel, leading the cleaning fluid through the microfluidic channel with the magnetic field, collecting undesired materials on the surfactant coated magnetic nanoparticles, and removing the cleaning fluid along with the collected undesired materials from the microfluidic channel.

In an embodiment, a cleaning fluid includes magnetic nanoparticles coated with surfactant.

In an embodiment, a method for producing a cleaning fluid includes coating nanoparticles of a magnetic material with surfactant to produce coated nanoparticles, and dispersing the coated nanoparticles in a liquid carrier.

### BRIEF DESCRIPTION OF THE FIGS.

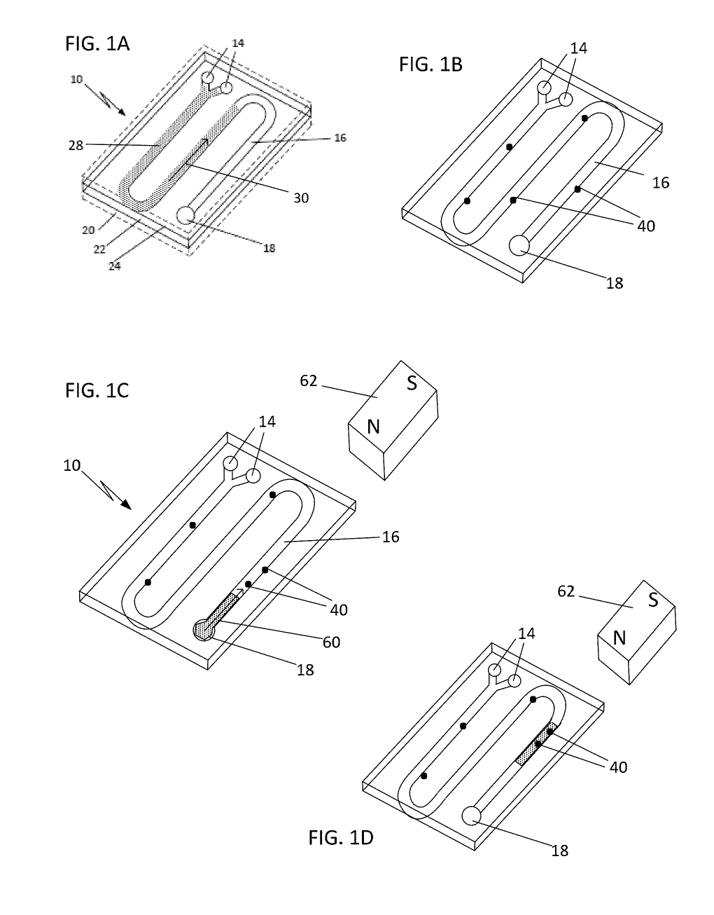

FIGS. 1A-1D depicts a representation of a use and cleaning of ‘Lab on a Chip’ device according to an embodiment.

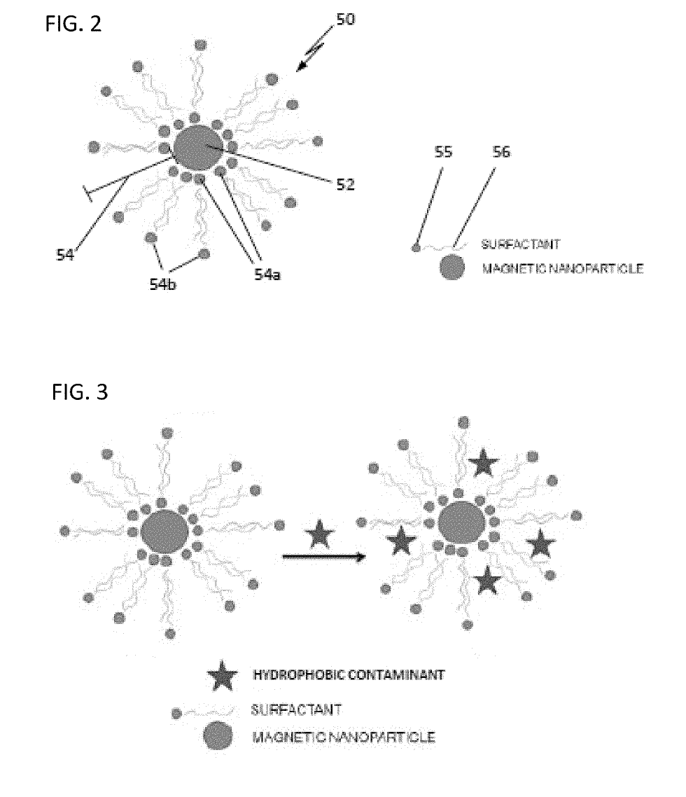

FIG. 2 provides a representation of a surfactant coated magnetic nanoparticle according to an embodiment.

FIG. 3 depicts adsorption of a contaminant by a surfactant coated magnetic nanoparticle according to an embodiment.

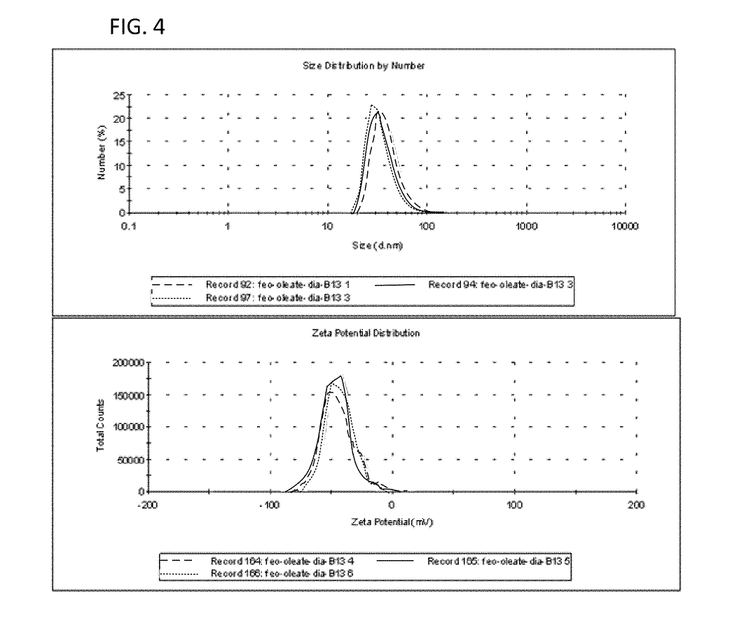

FIG. 4 is graphical data showing the Zeta potential of surfactant coated magnetic nanoparticies according to an embodiment.

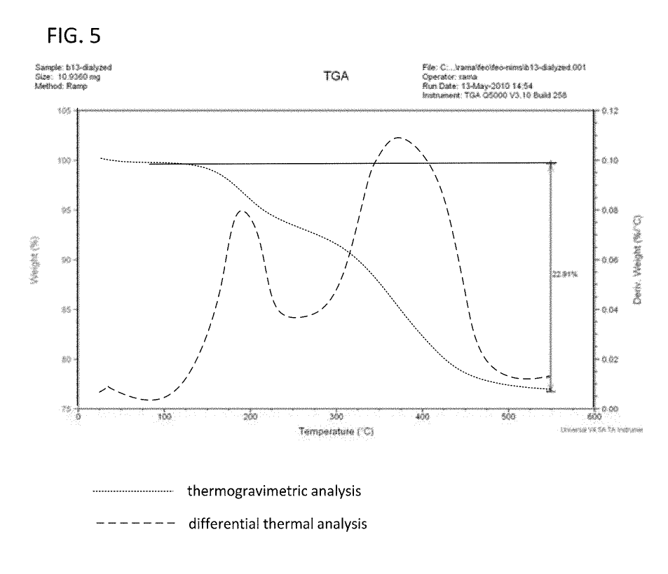

FIG. 5 is graphical data showing a thermogravimetric analysis of surfactant coated magnetic nanoparticles according to an embodiment.

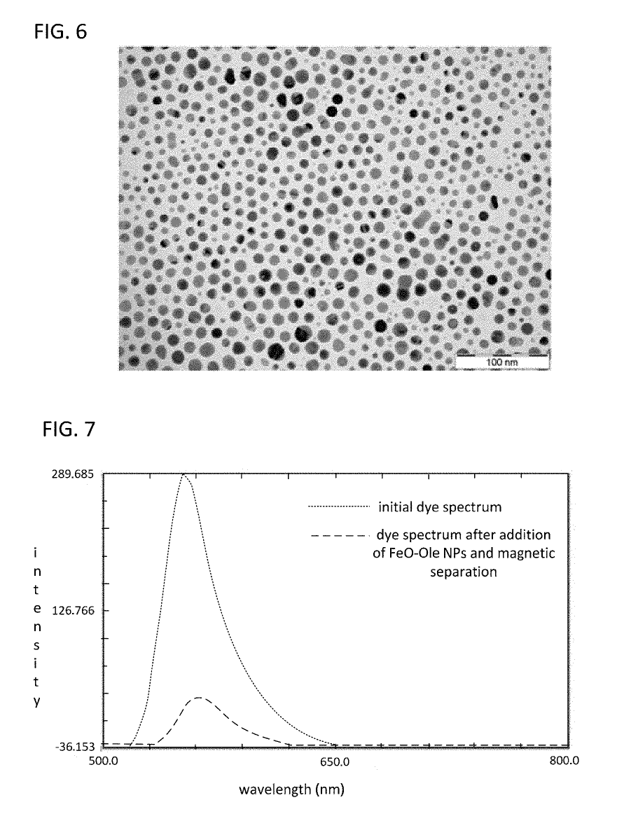

FIG. 6 is a transmission electron microscope image of surfactant coated magnetic nanoparticies according to an embodiment.

FIG. 7 is a spectral data analysis of a dye sample prior to and after removal of dye with surfactant coated magnetic nanoparticle according to an embodiment.

FIG. 8 is a photograph of a Lab-On-Chip (LOC) device after use with a rhodamine dye. Residual dye is visible throughout the device's channel.

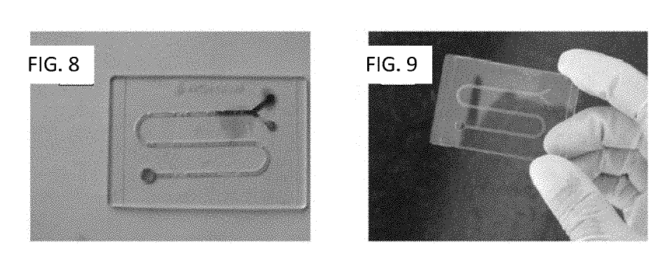

FIG. 9 is a photograph of the Lab-On-Chip (LOC) device from FIG. S after cleaning with the nanoparticle solution of FIG. 1. No residual dye is visible throughout the device.

### DETAILED DESCRIPTION

A simplified representation of an embodiment of a Lab-On-Chip (LOC) device 10 is depicted in FIG. IA. The LOC device 10 may include at least one inlet port 14 (two are shown) into which a sample and or reagents may be introduced into the device. The LOC device 10 may also include a microfluidic channel 16 and at least one outlet port 18. Microfluidic channels 16, for example, may have a cross-sectional dimension of about 0.5×10⁶ nm to about 1.5×10⁶ nm. As depicted with dashed lines for simplification of the drawings, in an embodiment, such a device 10 may have several layers that may include a base layer 20, a channel layer 22, and a cover plate 24. The base layer 20 may be a solid plate. The channel layer 22 may have the channel 16 formed within the layer or on the layer. The cover plate 24 may be a solid plate with openings corresponding to the ports 14 and 18. At least one of the base plate 20 and the cover plate 24 may provide the top or bottom surfaces that enclose the channel 16. The various plates/layers may be made from a variety of materials, including, but not limited to quartz, wood, glass, ceramic, metal, and polymers, or any combination thereof. Some examples of polymers may include, but are not limited to, polydimethylsiloxane (PDMS), poly(methyl methacrylate) (PMMA), polyethylene (PE), polyethylene terephthalate (PET), conducting polymers, or any combination thereof. Some examples of conducting polymers may include polyacetylene, polyphenylene vinylene, polypyrrole, polythiophene, polyaniline, and polyphenylene sulfide.

For use, a fluid or fluids 28. for example, may include a test sample and a reagent, nay be introduced into the respective inlet ports 14. The fluids 28 may move along the channel 16, as represented in FIG. 2, in the direction of arrow 30 towards the outlet port 18. The fluid 20 may move along the channel via capillary action, or movement through the channel 16 may be induced or enhanced by suction via the port 18 or pressure via the ports 14, or both. A reaction between fluid and reagent may be occurring as the fluid moves along the channel 16.

The LOC devices 10 may be reusable, and therefor may be cleaned after use, or alternatively may be disposable. After analysis of the sample is completed, fluid 28 may be removed by forcing the fluid out of the channel 16, such as by blowing air or gas through the channel, for example, or alternatively by using a vacuum and suctioning the fluid from the channel. Residual components 40, as depicted in FIG. IB, may however remain behind. Some residual components may be rinsed out with water, while other components 40 may ad.here/adsorb onto the walls of the channel, and a cleaning fluid may be needed to remove the adhering components.

A cleaning fluid 60, as represented in FIG. 1C, may be introduced into the channel 16 to clean the channel. In an embodiment, a cleaning fluid may be configured as a magnetic-surfactant hybrid having nano-dimension particles that are of a size that enables the particles to flow through microfluidic channels. Because of the magnetic properties of the particles, the fluid may be guided along the channels and through the device via exposure to a magnetic field that may pull or push the fluid along the channels. The fluid may be configured to collect and clean up a specific contaminant, or alternatively, may be configured as a general cleaning solution to collect multiple ones of a variety of different contaminants, In an embodiment, for example where a device 10 may have residual dyes adsorbed to surfaces within the channel 16, the cleaning fluid 20 may be configured with a surfactant that specifically attracts, hinds, and carries away the particular dye that is used.

As represented in FIG. 2, a surfactant coated magnetic nanoparticle 50 may include a nanoparticle magnetic core 52 and a surfactant coating 54. The coating 54 may include a plurality of amphiphilic molecules 54a, 54b disposed about and associated with the nanoparticle magnetic core 52. As represented in FIG. 2, the surfactant coating 54 may include a bilayer of amphiphilic molecules wherein a first layer of amphiphilic molecules 54a may have hydrophilic ends 55 disposed towards the core, and lipophilic ends 56 disposed away from the core, and a second layer of amphiphilic molecules 54b may have lipophilic ends disposed adjacent to the lipophilic ends of the first layer and hydrophilic ends disposed away from the first layer.

A magnetic-surfactant hybrid cleaning fluid may include surfactant coated magnetic nanoparticles 50 having a size of less than or equal to about 100 nm. In an embodiment, the surfactant coated magnetic nanoparticles 50 may have a size (cross-sectional dimension) of from about 1 nm to about 100 nm, or from about 1 nm to about 50 nm, or from about 1 nm to about 30 nm, or from about 1 nm to about 20 nm, or from about 1 nm to about 10 nm. In various embodiments, the lower size limit of the above ranges may, instead of being 1 nm, be about 5 nm, or may be about 10 nm. As an example, the surfactant coated magnetic nanoparticles may have a size (cross-sectional dimension) of from about 5 nm to about 10 nm.

The surfactant coated magnetic nanoparticles 50 may have a core 52 that is a magnetized material or magnetizable material. The core material may be ferromagnetic, superparamagnetic, or paramagnetic. In embodiments, the core 52 may be a metal selected from Fe, Mn Co, Ni, Nd, Gd, Eu, alloys of these metals, or any combination of these metals and alloys thereof Some specific examples of magnetic core metals may include FeO, Fe₂O₃, and Fe₃O₄. The metal nanoparticles may be bimetallic or trimetallic nanoparticles. Some examples of bimetallic magnetic nanoparticles may include, but are not limited to, CoPt, fcc phase FePt, fct phase FePt, FeCo, MnAl, MnBi, and mixtures thereof Some examples of trimetallic nanoparticles may include, but are not limited to, tri-mixtures of the above magnetic nanoparticles, or core/shell structures that form trimetallic nanoparticles such as cobalt covered fct phase FePt. In certain embodiments, the metal nanoparticles may include a bimetallic or a trimetallic core.

The surfactant coated magnetic nanoparticles 50 may have any possible shape or configuration, regular or irregular. Some examples of the shapes of the magnetic nanoparticles may include, but are not limited to, needle-shaped, granular, globular, platelet-shaped, acicular, colu ar, octahedral, dodecahedral, tubular, cubical, hexagonal, oval, spherical, dendritic, prismatic, amorphous shaped, or any combination of the above shapes. An amorphous shape may be defined as an irregular shape, not readily definable or having no clear edges or angles. In embodiments, the ratio of the major to minor size axis of magnetic nanocrystal (D major/D minor) may be less than about 10:1, less than about 2:1, or less than about 3:2. In a specific embodiment, the magnetic core may have a needle-like shape with an aspect ratio of about 3:2 to less than about 10:1.

The magnetic nanoparticles 52 may be prepared by ball-milling attrition of larger particles (a common method used in nano-sized pigment production), followed by annealing. Annealing may be needed because ball milling produces amorphous nanoparticles that may be subsequently crystallized into a single crystal form. The nanoparticles may also be made directly by radio frequency (RF) plasma. Appropriate large-scale RF plasma reactors are commercially available, such as from Tekna Plasma Systems (Sherbrooke, Quebec, Canada).

Magnetic materials have a remanent magnetization, or remanence, that is the magnetization left behind in the material after an external magnetic field is removed. In embodiments, the magnetic nanoparticles 52 may have a remanence of about 20 emu/gram to about 100 emu/gram, from about 30 emu/gram to about 80 emu/gram, or from about 50 emu/gram to about 70 emu/gram, or values outside of these ranges.

In embodiments, the coercivity of the magnetic nanoparticles 52 may be about 200 Oersteds to about 50,000 Oersteds, about 1,000 Oersteds to about 40,000 Oersteds, or about 10,000 Oersteds to about 20,000 Oersteds, or values outside of these ranges.

In embodiments, the magnetic saturation moment of the magnetic nanoparticles 52 may be, for example, about 20 emu/gram to about 150 emu/gram, about 30 emu/gram to about 120 emu/gram, or about 40 emu/gram to about 80 emu/gram, or values outside of these ranges.

The surfactant coated magnetic nanoparticles 50 may include a magnetic metal core 52 with a coating material or shell 54 of surfactant. In an embodiment, the coated magnetic nanoparticles 50 may include a surfactant coating/shell having a thickness of from about 0.2 nm to about 100 nm, or from about 0.5 nm to about 50 nm, or from about 2 nm to about 20 nm, or from about 1 nm to about 10 nm.

Any suitable or desired surfactant coating material, or combination of surfactant coating materials may be provided as the coating or shell. In embodiments, the coating material may include a surfactant coating or mixtures and combinations of surfactants. In embodiments, the magnetic nanoparticles may include a micellar double layer (liposome type) that includes a surfactant selected from beta-hydroxy carboxylic acids, fatty acids, beta-hydroxy carboxylic esters, sorbitol esters, polymeric compounds, block copolymer surfactants, derivatives and combinations thereof. Some examples of derivatives may include salts, hydroxy acids, amides, esters, ethers, or any combination thereof. The fatty acids may be monounsaturated fatty acids. An example of a salt derivative may include sodium linoleate.

Some examples of surfactants may include, but are not limited to, C-18 fatty acids (oleic acid, stearic acid, linoleic acid, vaccenic acid), oleyl amine, trioctyl phosphine oxide (TOPO), hexyl phosphonic acid (HPA), polyvinylpyrrolidone (PVP), surfactants sold under the name SOLSPERSE® such as Solsperse® 16000, Solsperse® 28000, Solsperse® 32500, Solsperse® 38500, Solsperse® 39000, Solsperse® 54000, Solsperse® 17000, Solsperse® 17940 from LubriZol Corporation, beta-hydroxy carboxylic acids and their esters containing long linear, cyclic or branched aliphatic chains, such as those having about 5 to about 60 carbons, such as pentyl, hexyl, cyclohexyl, heptyl, octyl, nonyl, decyl, undecyl, and the like; sorbitol esters with long chain aliphatic carboxylic acids, such as lauric acid, oleic acid (SPAN® 85), palmitic acid (SPAN® 40), and stearic acid (SPAN® 60), polymeric compounds such as poly (1-vinylpyrrolidone)-graft-(1-hexadecene), poly(1-vinylpyrrolidone)-graft-(1-triacontene), cetyl trimethyl ammonium bromide, oleyl amine, trioctyl phosphine oxide, tributyl phosphine, hexyl phosphonic acid, polyvinylpyrrolidone, lauric acid, palmitic acid, poly(1-vinylpyrrolidone) graft-(1-hexadecene), poly(1-vinylpyrrolidone)-graft-(1-vinylpyrrolidone)-graft-(1-hexadecene), poly(1-vinylpyrrolidone)-graft-(1-triacontene), pentyl beta-hydroxy carboxylic acid, hexyl beta-hydroxy carboxylic acid, cyclohexyl beta hydroxy carboxylic acid, heptyl beta-hydroxy carboxylic acid, octyl beta-hydroxy carboxylic acid, nonyl beta-hydroxy carboxylic acid, decyl beta-hydroxy carboxylic acid, undecyl beta-hydroxy carboxylic acid, 1-butanol, and any combinations thereof.

In an embodiment, surfactant coated nanoparticles 50 may be prepared by coating nanoparticles of a magnetic material 52 with surfactant. Coating the nanoparticles may include forming a bilayer of amphiphilic molecules 54a, 54b about a nanoparticle core 52, so that the bilayer may be configured as a first layer of amphiphilic molecules 54a having hydrophilic ends 55 disposed towards the core and lipophilic ends 56 disposed away from the core, and a second layer of amphiphilic molecules 54b having lipophilic ends disposed adjacent the lipophilic ends of the first layer and hydrophilic ends disposed away from the first layer.

In an embodiment, surfactant coated nanoparticles 50 may be prepared by performing the fabrication of metal nanoparticles from metal precursors in the presence of a suitable surfactant in a solvent. Suitable methods for preparing surfactant coated magnetic metal nanoparticles in solvent may include metal salts reduction by borohydrides, reduction of metal salts by polyols, and thermal decomposition of metal carbonyls.

In a process for reduction of metal salts by borohydrides, nanodroplets (reverse micelles) containing water soluble metal salts in water may be dispersed in an organic solvent. The metal salts may be reduced to the metal form (degree of oxidation is zero) by borohydride ions present in the nanodroplet. The process may provide stabilized surfactant coated metal nanoparticles. Typical metal precursors may include, but are not limited to Fe(II) and Co(II) salts such as FeCl₂ or CoCl₂. Some surfactant coatings that may be configured via this method may include, but are not limited to, 1-butanol, high molecular weight alcohols, oleic acid, CTAB (cetyl trimethvl ammonium bromide), and oleyl phosphine.

In an embodiment, for example, wherein the surfactant may be sodium oleate, the process of coating nanoparticles may include converting oleic acid to sodium oleate, and coating the nanoparticles with the sodium oleate. In an additional embodiment, for example, the coated nanoparticles may be iron oxides coated with sodium oleate. The process of coating may include mixing an iron chloride hydrate and sodium oleate in an aqueous solution, and introducing a reducing agent into the aqueous solution to reduce iron chloride to iron oxide. The iron chloride hydrate may be at least one of iron (III) chloride hexahydrate and iron (II) chloride tetrahydrate, and the reducing agent may be ammonia.

A cleaning fluid may be produced from any configuration of coated magnetic nanoparticle as described above by dispersing the coated magnetic nanoparticle in an appropriate liquid carrier. In an embodiment, the liquid carrier may be aqueous to provide an aqueous cleaning fluid. Due to the magnetic properties, the coated particles may be attracted and/or repulsed by an appropriate magnetic field, and movement of the particles may be guided by application of an appropriate magnetic field in the vicinity of the particles.

As represented in FIG. 3, surfactant coated magnetic nanoparticles may be used to pick up and carry away contaminants such as hydrophobic contaminants that may include dyes, drugs, oils, or combinations thereof. The double layer structure provides an internal hydrophobic region that is capable of adsorbing hydrophobic contaminants.

In an embodiment, a microfluidic channel may be cleaned by introducing a microfluidic channel cleaning fluid that contains surfactant coated magnetic nanoparticles to an opening of the microfluidic channel, applying a magnetic field adjacent the microfluidic channel, and leading the cleaning fluid through the microfluidic channel with the magnetic field. As schematically represented in FIGS. 1C and ID, a cleaning fluid 60 may be introduced into a microfluidic channel 16 via a port 18. By placing the device 10 adjacent an appropriate magnetic field (provided for example by a magnet 62), the cleaning fluid may be drawn through the microfluidic channel 16 towards the magnet. Thus, by altering the lative orientation between the device 10 and the magnet 62 the cleaning fluid may be guided through the microfluidic channel 16 to remove contaminants 40 from the channel.

In an embodiment, undesired materials 40 may be removed from a microfluidic channel 16 by introducing a cleaning fluid 60 that contains magnetic nanoparticles coated with surfactant into an opening of a microfluidic channel, applying a magnetic field adjacent the microfluidic channel, leading the cleaning fluid through the microfluidic channel with the magnetic field, collecting undesired materials on the surfactant coated magnetic nanoparticles, and removing the cleaning fluid along with the collected undesired materials from the microfluidic channel.

In an embodiment, the microfluidic channel 16 may define a longitudinal direction extending through the microfluidic channel from the opening, and the cleaning may include positioning the magnet 62 away from the cleaning fluid in the longitudinal direction to pull the cleaning fluid towards the magnet longitudinally through the microfluidic channel.

As the cleaning fluid passes through the channel, the amount of undesired material present in the channel may be reduced or eliminated as the cleaning fluid picks up and carries away the undesired material. In an embodiment, all or substantially all of the undesired material may be removed from the channel. Depending on the hydrophobicity or hydrophilicity of the undesired material, the undesired material may be attracted to and. collected on the lipophilic ends, the hydrophilic ends, or both of the surfactant molecules. For example, hydrophobic dyes may be attracted to and collected on the lipophilic ends.

After the cleaning fluid has traversed the length of the microfluidic channel, or at least a portion of the microfluidic channel that needs cleaning, the cleaning fluid may be removed from the microfluidic channel, for example by guiding the cleaning fluid to an opening and drawing the fluid out of the channel. Alternatively, after the cleaning fluid has traversed the length of the microfluidic channel, or at least a portion of the microfluidic channel, the cleaning fluid may be guided back toward the opening into which it was presented, thus causing the cleaning fluid to traverse the microfluidic channel two times to provide enhanced cleaning. The cleaning fluid may be guided ‘back-and-forth’ through the microfluidic channel a plurality of times to collect additional undesired material if any remains present in the channel.

After removing the used cleaning fluid, the microfluidic channel may be rinsed with water to remove any additional cleaning fluid. In an alternative embodiment, after removing the used cleaning fluid, an additional amount of the same cleaning fluid may be used to provide an additional cleaning of the channel, or an alternative type of cleaning fluid configured as described above, may be introduced and used to further clean the channel of a different type of undesired material that might be present. One type of cleaning fluid may be configured to remove a first type of undesired material and other cleaning fluids may be configured to remove additional types of undesired material. The number and types of cleaning fluids may be selected as needed to provide a clean and reusable LOC device.

The magnetic nanofluid may be water based and hence may be used to clean organic polymer based channels, and may also be used to remove any fluorescence background signal interference. The total time required for the process may depend on the amount of adsorbed material to be removed. The nanohybrids may be non-toxic in nature, and similarly, an aqueous cleaning solution containing the nanohybrids may be non-toxic as well. The material and process may provide an inexpensive and viable method and material for their usage. Using the material proposed in the current patent, it will be easier to remove the adsorbed dye using a bar magnet. The materials that will be used do not have any toxic effects and also have no effect on the microfluidic channel.

### EXAMPLE 1

### Preparation of Surfactant-Coated Magnetic Nanoparticles

Surfactant-coated magnetic nanoparticles of iron oxides coated with sodium oleate are produced according to the method below with the following chemicals: iron (II) salt (Sigma-Aldrich 44939); iron (III) salt (Sigma-Aldrich 236489); oleic acid (Merck 112-80-70); ammonia solution (25%) in water (Merck AB3A630079); sodium hydroxide (Rankem S0290) and Milli-Q water.

Oleic acid was converted to oleate by mixing equal molar ratios of NaOH and the oleic acid. About 140 mg of the oleic acid was placed in a vial, and about 5 ml of about 0.1 M NaOH solution was added. The mixture was shaken overnight (about 12 hours) to provide an oleate solution.

Iron oxide nanoparticles stabilized by sodium salt of oleic acid (FeO-Ole NPs) were prepared wherein the oleate adsorbed onto the surface of the FeO nanoparticles and acts as an in situ stabilizing agent. About 0.32 g iron (III) chloride hexahydrate and about 0.12 g iron (II) chloride tetrahydrate were mixed in 9 ml of water. About 5 ml of the oleate solution (5 ml) was added drop-wise to the 9 ml iron/mixed salt solution under sonication and shaking, The resulting brownish suspension was shaken vigorously for about 30 minutes. To this mixture was quickly added about 3 ml of concentrated ammonia solution, and the resultant mixture was shaken vigorously for about 30 minutes. The addition of ammonia resulted in a blackish suspension. The suspension was transferred into a reactor (high temperature/pressure vessel) and sealed, and was kept about at 80° C. for about 8 hours.

### EXAMPLE 2

### Characterization of the Surfactant-Coated Magnetic Nanoparticles

Zeta Potential (electrokinetic potential in colloidal systems)—The zeta potential is the potential difference between the dispersion medium and the stationary layer of fluid attached to the dispersed particle, and may be related to the stability of colloidal dispersions. FeO-Ole nanoparticles of Example 1 were purified with water and analyzed for zeta potential by dynamic light scattering using a Zetasizer from Malvern Industries. As shown in FIG. 4, the zeta potential was determined to be about −39 mV, a value that indicates moderate to good stability.

Thermogravimetric Analysis—a thermogravimetric analysis of FeO-Ole nanoparticles of Example 1, was done using a Thermogravimetirc Analyzer from TA Instruments, The thermograyimetric diagram, shown in FIG. 5, indicates the presence of a double layer structure of oleate as shown in FIG. 2.

Particle Size Distribution—a transmission electron microscopic image was taken using a transmission electron microscope, Tecnai F20 from FEI. The image, shown in FIG. 6, shows the particle size distribution of the FeO-Ole nanoparticles of Example 1. The average particle size was determined to be about 5 nm.

### EXAMPLE 3

### Removal of Dye from an Aqueous Solution

FeO-Ole nanoparticles of Example 1 were used to clarify an aqueous solution of rhodamine dye. An aqueous solution of a rhodamine dye was made and a fluorescence spectra was recorded on a Shimadzu Fluorescence spectrophotometer after excitation at 480 nm (upper line in FIG. 7). The magnetic nanofluid was added to the solution. After 1 minute, the material was separated with the use of a bar magnet. A second fluorescence spectra was recorded (bottom line in FIG. 7). The spectra after the separation showed that the intensity was diminished by about 200% indicating that the dye was being removed from the medium onto the FeO-Ole nanoparticles.

### EXAMPLE 4

### Cleaning a Microfluidic Channel

A Lab-On-Chip (LOC) device, shown in FIGS. 8 and 9, and having channels formed in poly(methyl methacrylate) (PMMA), was used for an analysis measuring fluorescence with rhodamine dye. The LOC device, after use, is shown in FIG. 8. The device was first flushed with water to remove a portion of the materials present in the channel. A drop of the FeO-Ole nanoparticle solution of Example 1 was added to one of the openings in the channel. Using a magnet as shown and described relating to FIGS. 1C and 1D, the fluid was guided through the channel. The channel was flushed again with water and upon testing, no remaining dye was visible in the channel. The LOC device, after cleaning, is shown in FIG. 9.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particularmethods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be nterpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to at least one of A, B, or C, etc.” is used, in general such a construction is intended in the sense one having skill in the art would understood the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood h one skilled in the art, a range includes each individual member. Thus, for example, a group having 1-3 cells refers to groups having 1, 2 or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method for cleaning a microfluidic channel, the method comprising:
introducing a cleaning fluid to an opening of the microfluidic channel, the cleaning fluid comprising surfactant coated magnetic nanoparticles having a bilayer of amphiphilic molecules comprising:
a first layer of amphiphilic molecules with hydrophilic ends disposed towards a magnetic core of the nanoparticles and lipophilic ends disposed away from the magnetic core; and
a second layer of amphiphilic molecules with lipophilic ends disposed adjacent the lipophilic ends of the first layer and hydrophilic ends disposed away from the first layer;
applying a magnetic field adjacent the microfluidic channel; and
leading the cleaning fluid through the microfluidic channel with the magnetic field.

2. (canceled)

3. The method of claim 1, wherein introducing comprises introducing a cleaning fluid to a microfluidic channel having a longitudinal direction extending through the microfluidic channel from the opening, and the method further comprises positioning a magnet away from the cleaning fluid in the longitudinal direction to pull the cleaning fluid towards the magnet longitudinally through the microfluidic channel.

4. (canceled)

5. The method of claim 1, wherein introducing comprises introducing the cleaning fluid to a microfluidic channel having a cross-sectional dimension of about 0.8×10⁶ nm to about 1.0×10⁶ nm, and the introducing a cleaning fluid having surfactant coated magnetic nanoparticles with a cross-sectional dimension of about 5.6 nm to about 8.8 nm.

6.-7. (canceled)

8. The method of claim 1, wherein introducing a cleaning fluid comprises introducing magnetic nanoparticles having ferromagnetic cores and a bilayer having amphiphilic molecules comprise comprising at least one of fatty acids and fatty acid derivatives.

9. The method of claim 1, wherein introducing a cleaning fluid comprises introducing surfactant coated magnetic nanoparticles having magnetic cores of iron, an iron alloy, cobalt, a cobalt alloy, nickel, a nickel alloy, manganese, a manganese alloy, neodymium, a neodymium alloy, gadolinium, a gadolinium alloy, europium, a europium alloy or any combination thereof.

10. The method of claim 8, wherein introducing a cleaning fluid comprises introducing surfactant coated magnetic nanoparticles having magnetic cores of FeO, Fe₂O₃, Fe₃O₄, or any combination thereof.

11.-12. (canceled)

13. The method of claim 1, wherein introducing a cleaning fluid comprises introducing surfactant coated magnetic nanoparticles having amphiphilic molecules comprising a moiety of oleic acid, a moiety of stearic acid, a moiety of linoleic acid, a moiety of vaccenic acid, or any combination thereof.

14. The method of claim 1, wherein introducing a cleaning fluid comprises introducing surfactant coated magnetic nanoparticles having amphiphilic molecules comprise comprising sodium oleate.

15. The method of claim 1, wherein introducing a cleaning fluid comprises introducing an aqueous solution, wherein the amphiphilic molecules comprise sodium oleate, and the magnetic nanoparticles are FeO, Fe₂O₃, or any combination thereof.

16. The method of claim 1, wherein introducing a cleaning fluid comprises introducing nanoparticles of iron oxides coated with sodium oleate.

17.-34. (canceled)

35. A cleaning fluid comprising magnetic nanoparticles coated with surfactant, wherein the surfactant comprises a bilayer of amphiphilic molecules comprising:
a first layer of amphiphilic molecules with hydrophilic ends disposed towards a core of the magnetic nanoparticles and lipophilic ends disposed away from the core; and
a second layer of amphiphilic molecules with lipophilic ends disposed adjacent to the lipophilic ends of the first layer and hydrophilic ends disposed away from the first layer.

36.-37. (canceled)

38. The cleaning fluid of claim 35, wherein the magnetic nanoparticles are ferromagnetic.

39. The cleaning fluid of claim 35, wherein the magnetic nanoparticles comprise iron, an iron alloy, cobalt, a cobalt alloy, nickel, a nickel alloy, manganese, a manganese alloy, neodymium, a neodymium alloy, gadolinium, a gadolinium alloy, europium, a europium alloy or any combination thereof.

40. The cleaning fluid of claim 35, wherein the magnetic nanoparticles are FeO, Fe₂O₃, Fe₃O₄, or any combination thereof.

41. The cleaning fluid of claim 35, wherein the surfactant comprises a fatty acid, a fatty acid derivative, or any combination thereof.

42. The cleaning fluid of claim 41, wherein the fatty acid derivative comprises a salt, a hydroxy acid , an amide, an ester, an ether, or any combination thereof.

43. The cleaning fluid of claim 35, wherein the surfactant is selected from the group consisting of a monounsaturated fatty acid moiety, a C₁₈ fatty acid moiety, an oleic acid moiety, a of stearic acid moiety, a of linoleic acid moiety, a of vaccenic acid moiety.

44.-45. (canceled)

46. The cleaning fluid of claim 35, wherein the surfactant comprises sodium oleate.

47. The cleaning fluid of claim 35, wherein the surfactant coated magnetic nanoparticles have a cross-sectional dimension of about 5.6 nm to about 8.8 nm.

48. The cleaning fluid of claim 35, wherein the cleaning fluid is an aqueous solution, the surfactant comprises sodium oleate, and the magnetic nanoparticles are FeO, Fe₂O₃, or any combination thereof.

49. A method for producing a cleaning fluid, the method comprising:
coating nanoparticles of a magnetic material with surfactant to produce coated nanoparticles by forming a bilayer of amphiphilic molecules about a nanoparticle core, the bilayer comprising:
a first layer of amphiphilic molecules with hydrophilic ends disposed towards the core and lipophilic ends disposed away from the core;
a second layer of amphiphilic molecules with lipophilic ends disposed adjacent the lipophilic ends of the first layer and hydrophilic ends disposed away from the first layer; and
dispersing the coated nanoparticles in a liquid carrier.

50.-51. (canceled)

52. The method of claim 49, wherein coating nanoparticles comprises coating ferromagnetic nanoparticles.

53. The method of claim 49, wherein coating nanoparticles comprises coating magnetic nanoparticles comprising iron, iron alloys, cobalt, cobalt alloys, nickel, nickel alloys, manganese, manganese alloys, neodymium, neodymium alloys, gadolinium, gadolinium alloys, europium, europium alloys or any combination thereof.

54. The method of claim 49, wherein coating nanoparticles comprises coating FeO, Fe₂O₃, Fe₃O₄, or any combination thereof.

55. The method of claim 49, wherein coating nanoparticles comprises coating with a surfactant comprising a fatty acid, a fatty acid derivative, or any combination thereof.

56. (canceled)

57. The method of claim 49, wherein coating nanoparticles comprises coating with a surfactant comprising a moiety of oleic acid, stearic acid, linoleic acid, vaccenic acid, or any combination thereof.

58. The method of claim 49, wherein coating nanoparticles comprises coating with a surfactant comprising sodium oleate.

59. (canceled)

60. The method of claim 49, wherein coating nanoparticles comprises coating iron oxides with sodium oleate.

61.-62. (canceled)
